(19) United States
(12) Patent Application Publication
(10) Pub. No.: US 2004/0225960 A1
(43) Pub. Date: Nov. 11, 2004

(54) System for hosting graphical layout/presentation objects

(75) Inventors: Sujal S. Parikh, Redmond, WA (US); Dmitry Titov, Redmond, WA (US); Oleg Ovetchkine, Kirkland, WA (US); Gregory Lett, Redmond, WA (US); Grzegorz Zygmunt, Sammamish, WA (US); Debbie A. Newman, Redmond, WA (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: Microsoft Corporation, Redmond, WA

(21) Appl. No.: 10/434,850

(22) Filed: May 9, 2003

(51) Int. Cl. G06F 15/00

(52) U.S. Cl. 715/517

(57) ABSTRACT

A presenter system framework and methods performed by such framework are described for hosting a set of presenters that facilitate maintaining layouts for application views assigned a set of graphical elements. The presenter system provides a base presenter class and a set of interface methods, performed by a presentation engine, for creating and integrating an extensible set of presenter classes for handling various graphical element data types during a layout operation within a specified view. The presenter system enables application user interface developers to implement complex display layout operations through calls to the presentation engine. Examples of such complex display layout operations include: pagination, partial calculation, incremental calculation, multiple tries, chaining of layout features/operations.

### FIELD OF THE INVENTION

The present invention relates generally to computing devices. More particularly, the present invention relates to computing components for arranging graphical elements displayed via a graphical document/user interface.

### BACKGROUND OF THE INVENTION

Displaying and/or rendering graphical output for an application executing upon a computing system includes many tasks. One such task is layout/presentation management. Layout/presentation management concerns arranging and adorning a set of display elements within their assigned display spaces (e.g., rectangles). While “layout” and “presentation” may be distinguishable in other contexts, presentation and layout, as used herein, should be treated as interchangeable and equivalent terms. The layout/presentation system-processed display elements provide graphical output data to rendering components of a graphics output system and graphical display drivers. Such rendering components drive graphical display hardware such as monitors and printers.

The layout/presentation operations executed by computing systems comprise a wide variety of functions performed on graphical display elements. An example of such an operation is arranging text within assigned dimensions of an editor application's graphical display user interface. The layout operation determines the content and placement of the lines of text within a designated rectangular space. Another example is framing an element (e.g., a dialog box, a toolbar, a control bar, etc.) with a standardized border. The operations are also referred to herein as “features.” Rendering components of a computer system produce graphical output data based upon the state of the display elements that are potentially modified by previously executed layout/presentation operations/features.

Various presentation engines are known. For example, MICROSOFT WINDOWS' “user module” performs layout operations with regard to top-level windows on a graphical user interface. MICROSOFT WINDOWS' dialog box manager places objects at pre-defined positions and allows grouping of objects. The positioning of the objects occurs in a logical manner and is independent of a physical device. JAVA SWING permits basic placement operations with regard to objects within a view based on properties specified on the objects.

Layout/presentation operations have been performed in a number of manners. An application itself can fully carry out its display element layout operation. The layout (or “presentation”) operation is encapsulated within the application. The application adorns/arranges display elements for a view or view(s) associated with a current state of the application. The application arranges the elements within a display region assigned to the application. The application thereafter renders display output, corresponding to the arranged display elements, to the graphics system/drivers.

Another layout processing arrangement, incorporated into the MICROSOFT WINDOWS XP operating system, provides support for a pre-defined set of layout features that are callable by applications. The set of layout features comprise specialized layout/presentation operations for user interface graphical display elements of applications. The set of pre-defined layout/presentation features, such as for example, a border generator for supplied rectangles, reduces the programming load on application developers with regard to specific aspects of organizing and presenting elements of a graphical display. The set of pre-defined features also facilitates consistency with regard to executing certain basic display features/functions such as the aforementioned borders. Applications supplement the pre-defined layout functionalities with additional layout operations embedded within the applications themselves.

The known layout processing architecture, including pre-defined layout features callable by an application, simplifies programming layout tasks encountered by applications during the course of arranging a view before rendering graphical data and commands to rendering components of a computer system. However, the known layout processing architecture does not readily support enhancements or modifications with regard to the set of pre-defined layout features callable by the applications. Thus, for example, new layout features are placed directly into the application code rather than placing the features in the pre-defined layout features provided by the presentation/layout architecture. Thereafter, during execution, the application calculates the layout using a combination of the pre-defined layout functionalities and internally executed layout/presentation operations.

### SUMMARY OF THE INVENTION

The present invention comprises a presenter system for incorporation within a graphical output layout management system. Such layout management is directed to the way in which objects are arranged, sized, and placed upon a display space. Such systems process a layout, on behalf of a program providing graphical elements containing data representing displayable content of the program (e.g., a block of text that needs to be arranged on a displayed or printed page). The presenters perform a complimentary role to the graphical elements (that specify data) by defining display states for presenting the content of the graphical elements. As such, the presenters maintain a layout description for a corresponding graphical element.

In accordance with the present invention, the presenter system hosts and arranges the presenters associated with graphical elements within a view. The presenter system, in its role of supporting the derivation of presenters of many types, includes a presenter base class from which presenter classes are derived. Thereafter, presenters are instantiated from the derived presenter classes.

The presenter system also includes a presenter host interface. The host interface comprises a method for laying out graphical elements in a view in accordance with the presenters associated with the graphical elements. As such, the layout of the graphical elements within a view is specified by the associated presenters.

### BRIEF DESCRIPTION OF THE DRAWINGS

While the appended claims set forth the features of the present invention with particularity, the invention and its advantages are best understood from the following detailed description taken in conjunction with the accompanying drawings, of which:

FIG. 1 is a block diagram depicting an exemplary computer system for carrying out an embodiment of the invention;

FIG. 2 is a high level schematic diagram depicting the primary components of a layout management architecture including a presenter system for carrying out graphical layout maintenance in a computing system embodying the present invention;

FIG. 3 is a schematic drawing depicting the relationships between graphical elements and presenters defining a graphical document/user interface in a system embodying the present invention;

FIGS. 4a and 4b summarize the structure of a presenter base class from which customized presenter object classes are derived to carry out particular layout/rendering tasks in a system embodying the present invention;

FIG. 5 summarizes the structure of a child proxy class;

FIG. 6 summarizes the structure of a notification handler class interface;

FIG. 7 summarizes the structure of a notification handler site class;

FIG. 8 summarizes the structure of a view class;

FIG. 9 summarizes the parts of a BoxSizeInfo structure;

FIG. 10 summarizes the parts of a page descriptor structure;

FIG. 11 summarizes the structure of a presentation engine class;

FIG. 12 is a flowchart summarizing exemplary steps for notification handler-based processing of a change to a graphical element;

FIG. 13 is a flowchart summarizing exemplary steps for re-calculating and rendering a view comprising a set of presenters in accordance with an embodiment of the present invention; and

FIG. 14 is a flowchart illustratively depicting the steps for executing an update on a presenter (and associated affected children) in response to a change to a related graphical element.

### DETAILED DESCRIPTION OF THE DRAWINGS

A user interface and document layout/presentation architecture is disclosed herein. The disclosed layout/presentation architecture includes graphical layout processing/rendering components (presenters) that carry out view aspects of associated underlying data (graphical elements) for a document/user interface. A presenter system hosts the presenters. In its host role, the presenter system orchestrates and coordinates updating a view, comprising a set of presenters, in response to changes to corresponding graphical elements. Thus, the presenter system provides a mechanism that links the status (e.g., data state) of graphical elements to view states updated, cached, and rendered by corresponding presenter objects.

An aspect of the presenter system-based layout/presentation architecture embodying the present invention is its high degree of extensibility with regard to the types of presenters that it hosts. A presenter base class provided by the presenter system facilitates extending a set of presenter types (object classes) available for laying out and rendering information provided by a corresponding graphical element. The various presenter types derived from the presenter base class incorporate particular layout/rendering methods as overrides to default methods specified by the base presenter class. The presenter objects instantiated from the set of presenter object classes implement layout/presentation features according to the data state of a corresponding graphical element.

The presenter system hosts the presenter objects instantiated from the set of presenter object classes. The presenter system performs lifetime management (i.e., creation, deletion, etc.) of presenter objects. The presenter system handles dirty tracking to selectively update only the changed presenters. The presenter system supports chaining presenters together to provide adornments to main presenters. The presenter system also coordinates updating and rendering presenters.

Notification of changes to graphical elements potentially effecting the view states is facilitated, in an embodiment of the invention, by notification handlers. The notification handlers enable change notification handling to be separated from the change processing performed by presenters. Each presenter element type is associated with a notification handler type. Each notification handler processes changes to a corresponding graphical element. If updating is needed, then the notification handler initiates setting a dirtiness property on an associated presenter object. The set dirtiness property causes recalculation of a presenter object in response to the changes to the corresponding graphical element.

The user interface layout/presentation architecture, described by way of example herein, is incorporated into an operating system that hosts applications having graphical user/document interfaces. The applications, presenters, and device-specific rendering components of the operating system and device-specific drivers, render interface/document graphical output device control commands/data to display device hardware (e.g., monitors, printers, etc.). Layout features of the rendered output are based at least in part upon layout/presentation processing and rendering performed by the presenters hosted by the presenter system.

The presentation architecture enables disassociating a displayed element's data state from it's view state. Such disassociation provides an extensible and highly customizable platform for creating new and rich display personalities for an underlying graphical element. In an embodiment of the invention, a display element is represented by a graphical element object (representing the element's data state) and at least one associated presenter object (representing a view state) for laying out the element in a particular view. The presenter carries out customized updating of a layout for a related element. The presenter also renders the view of the element after updating the layout.

Utilizing presenter objects disassociates the data state of a displayed element and its display in a view. As a consequence, each graphical element (display data source) is potentially capable of having multiple presenters providing distinct views of the graphical element (e.g., a full scale and thumbnail view of a photograph element). The ability to associate multiple presenters with a single graphical element also enables a single element to be associated with multiple locations within a field (e.g., splitting a single graphical element between multiple columns). Also, the presenter system supports chaining multiple distinct presenters of differing types to a single element thereby supporting attaching a variety of customized adornments to a basic view for an element. These, as well as other aspects of an exemplary display layout/rendering architecture are described herein below with reference to the figures.

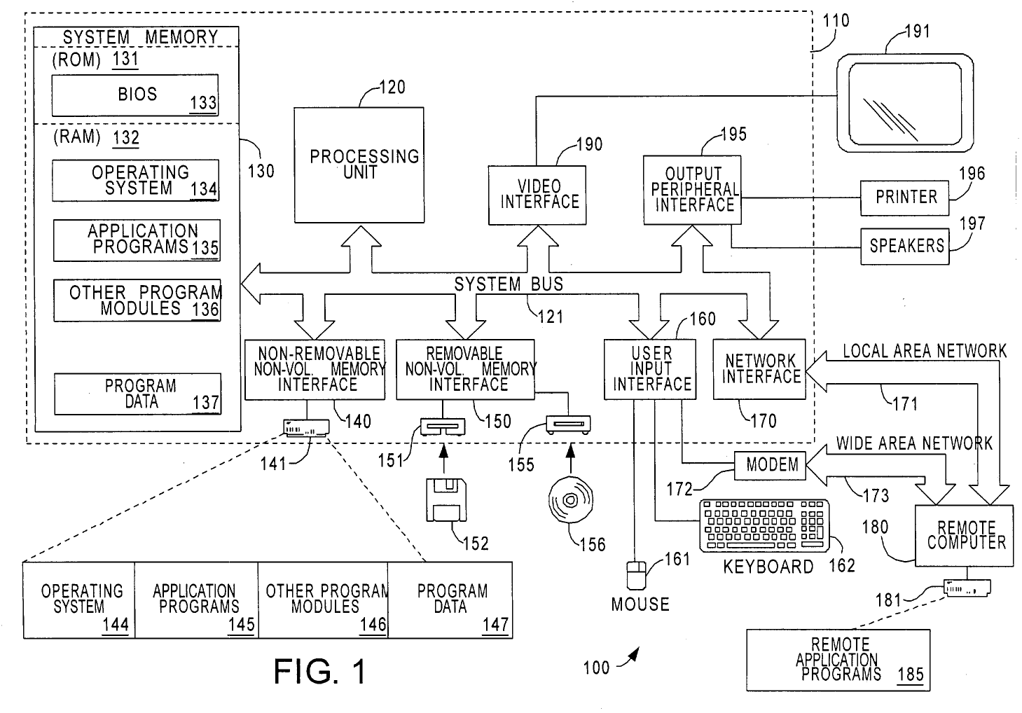

FIG. 1 illustratively depicts an example of a suitable operating environment 100 for carrying out the presenter system-based display layout/rendering architecture embodying the present invention. The operating environment 100 is only one example of a suitable operating environment and is not intended to suggest any limitation as to the scope of use or functionality of the invention. Other well known computing systems, environments, and/or configurations that may be suitable for use with the invention include, but are not limited to, personal computers, server computers, laptop/portable computing devices, hand-held computing devices, multiprocessor systems, microprocessor-based systems, network PCs, minicomputers, mainframe computers, distributed computing environments that include any of the above systems or devices, and the like. The disclosed layout management architecture including a presenter system serves a number of diverse interests including extensibility, integration, and uniformity with regard to the display functionality of a computing system, such as the one depicted in FIG. 1.

The invention is described in the general context of a set of steps and processes carried out by computer-executable instructions, such as program modules, being executed by a computer. Generally, program modules include routines, programs, objects, components, data structures, etc. that perform particular tasks or implement particular abstract data types. Though the exemplary embodiment is described with reference to locally executed processes on a single computer system, the invention is potentially incorporated within network nodes operating in distributed computing environments where tasks are performed by remote processing devices that are linked through a communications network. In a distributed computing environment, program modules are generally located in both local and remote computer storage media including memory storage devices.

With continued reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is sometimes stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through an non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device may also be connected to the system bus 121 via an interface, such as a video interface 190. In addition to the monitor, computers may also include other peripheral output devices such as speakers 197 and printer 196, which may be connected through an output peripheral interface 195.

The computer 110 potentially operates in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory storage device 181. It will be appreciated that the network connections shown are exemplary and other means of establishing a communications link between the computers may be used.

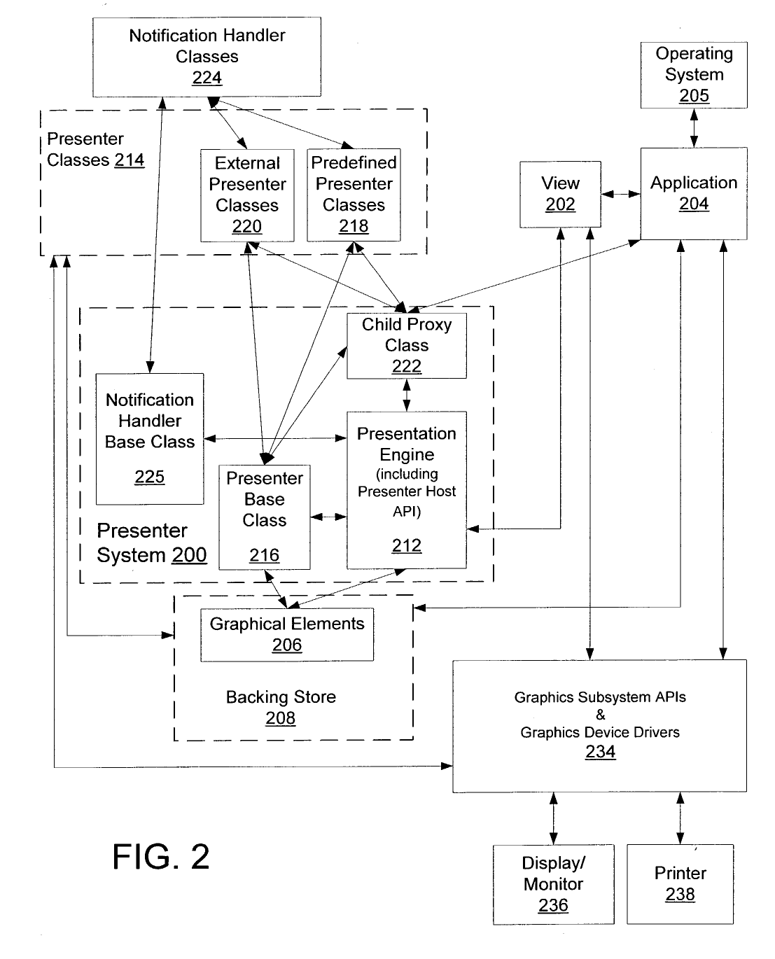

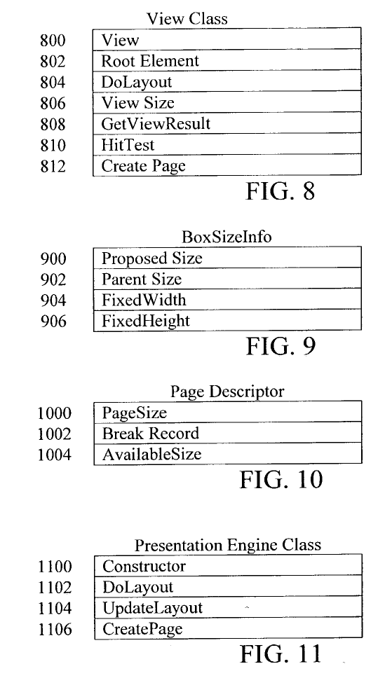

FIG. 2 is a high level schematic diagram identifying software modules and programs as well as instantiated objects and data components of a layout/presentation management system architecture embodying the present invention. The exemplary layout/presentation management system architecture represented in FIG. 2 includes a presenter system 200 that supports layout/presentation of displayable objects based upon a set of hierarchically arranged presenter objects associated with a view 202 created, from a view object class (see, FIG. 8 described herein below) at the request of an application 204 executing on an operating system 205.

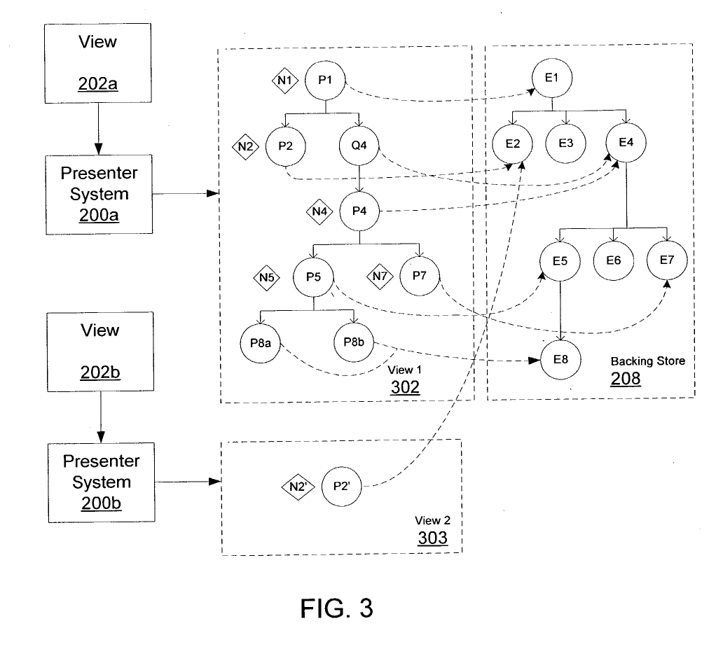

In an embodiment of the invention, each view (e.g., view 202) has a corresponding presenter system (e.g., presenter system 200) that is responsible for maintaining the displayable objects within the view. In an embodiment of the invention the view 202 is the visual root for all the visuals that are created by the presenter system 200. The displayed content within the view 202 is based upon graphical elements 206 within a backing store 208. The application 204 is a source of the graphical elements 206 within the backing store 208. An illustrative example depicting the relationships between views, presenter systems, presenter trees for views, and graphical element trees associated with an application is depicted in FIG. 3 described herein below.

The layout/presentation management system architecture depicted in FIG. 2 is divided into a set of functional components. The lines between the depicted components represent interaction paths between the components. The present invention is not limited to the particular arrangement of the components and their indicated exemplary interactions in the illustrative embodiment depicted in FIG. 2. Rather, the functionality of the components described herein below is grouped in different manners in accordance with alternative embodiments of the invention.

In an embodiment of the invention, the application 204 calls a constructor method on a view object class application program interface (See view class structure in FIG. 8 described herein below) to create a root object for the view 202 object instance. The method call to create the view 202 passes a reference to a root graphical element of the graphical elements 206 contained in the backing store 208. After creating the view 202, a call to a DoLayout method on the view 202 creates a presenter tree for the view 202 with a root presenter object corresponding to the root graphical element passed initially to the constructor method that created the view 202. The presenter tree (not shown in FIG. 2) for the view 202 comprises a set of presenters that are responsible for organizing and rendering visual output for the view 202.

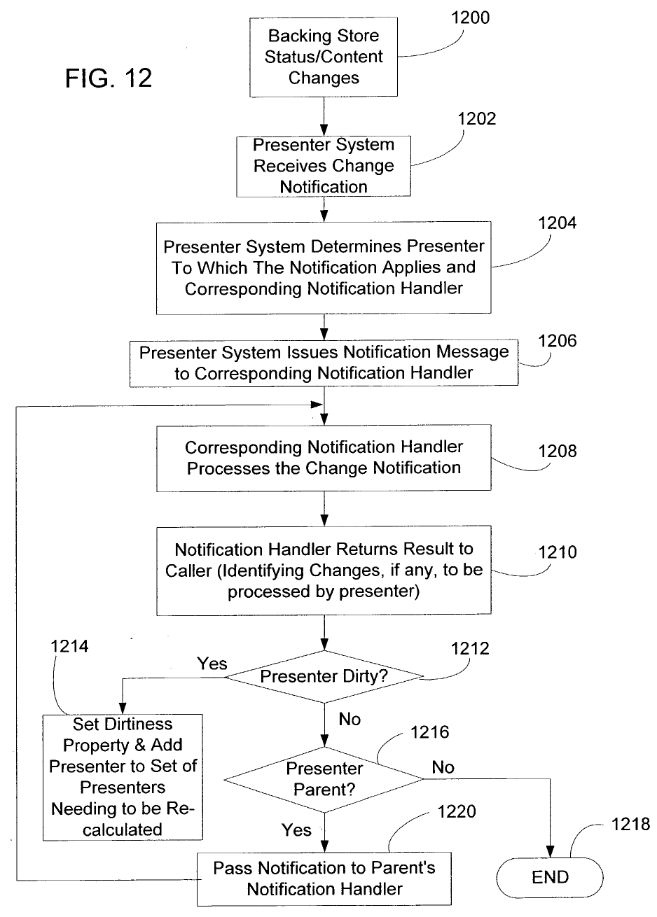

In an embodiment of the invention each view (e.g., view 202) owns a presenter system (e.g., presenter system 200). Thus, in response to the DoLayout method, the view 202 initiates creating a new presenter tree and returns it to the caller (e.g., application 204). Initially, the view 202 calls a constructor method on a presentation engine object class to create a presentation engine 212 instance including a presenter host application program interface (presenter host API). The presentation engine 212 includes executable code for coordinating and orchestrating execution of layout/presentation operations in a computing system supporting graphical output. Functions performed/coordinated by the presentation engine 212 include: creating presenter objects (both root and child versions), coordinating re-calculating presenters' display states, rendering, lifetime management of presenters, dirty tracking, chaining multiple presenters to a single element, and performing incremental layout. Examples of the callable methods on the presentation engine 212's presenter host API are described herein below with reference to FIG. 12. These methods are high level requests that create and maintain the presenter object tree for the view 202. The identified tasks performed by the presentation engine 212 are exemplary, and those skilled in the art will appreciate that additional/alternative tasks can be carried out by the presentation engine 212 in alternative embodiments of the invention.

The presentation engine 212 builds the presenter system 200 to handle presenter objects associated with the view 202. In an embodiment of the invention, the presenter system 200 includes a presenter base class 216. The presenter base class 216 is a full featured base class for creating presenter subclasses and presenter objects capable of exploiting the layout management functionality of the system described herein. The presenter base class 216 comprises a template, including virtual (overridable) program code and data structures, from which a set of presenter classes 214 are derived. The presenter classes 214 comprise a set of specialized presenter types corresponding to views, of graphical elements, having particular display properties/behaviors. Customized presenter classes 214 derived from the presenter base class 216, by way of example, lay out content, arrange children, create visuals for attached elements, paginate content for typographic documents, and incrementally update visuals including the graphical elements 206. The specialized functionality of each presenter class within the set of presenter classes 214 is established by overriding and supplementing the virtual methods defined by the presenter base class 216. Presenter objects instantiated from the set of presenter classes 214 represent and handle display aspects of the graphical elements 206.

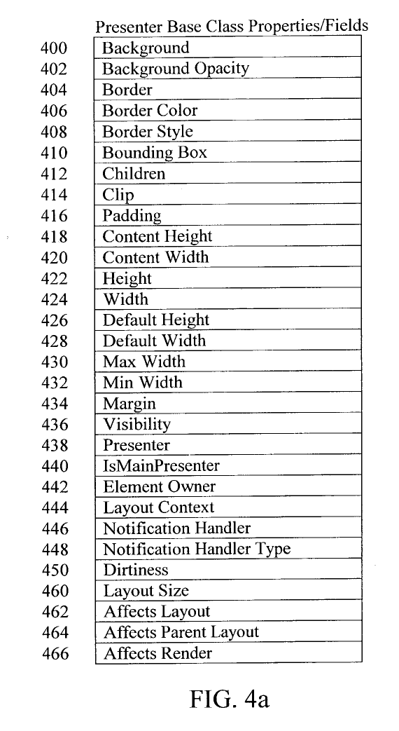

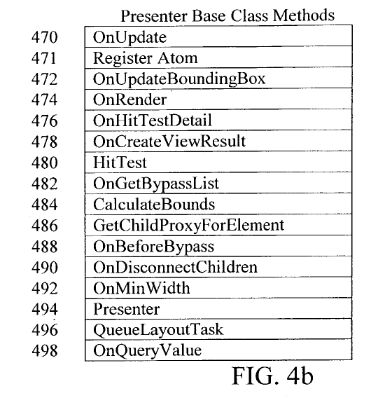

In an embodiment of the invention the set of presenter object classes 214, including both predefined presenter classes 218 and external presenter classes 220, is extensible. The set of predefined presenter classes 218 are provided with the presenter system 200. The external presenter object classes 220 are generally installed independently of the presenter system 200. However, properly integrating the external presenter object classes 210 with the presenter system 200 is facilitated by a published interface specification for the presenter base class 216 (described herein below with reference to FIGS. 4a and 4b). A developer of external presenter classes 220 overrides/modifies program code and data structures associated with the customizable layout/rendering methods of the presenter base class 216 to achieve custom sizing, child positioning, and rendering functions. Thereafter, the new presenter class is installed in the set of external presenter object classes 220, by for example, installing a file containing the new object class in a designated directory within a computer's file system.

In an embodiment of the invention, the presenter classes 214 include presenter classes for carrying out layout features including, by way of example: content layout, child object arrangement, visuals creation, document content pagination, and incremental update of visuals (e.g., HTML pages that span multiple display screens). Examples of specific presenter types include: a text presenter that measures and displays text formatted in various ways (e.g., bold, italic etc), an image presenter that measures and displays a specified image, and a dock presenter that partitions a space among multiple children presenters.

After creating the presenter system 200 and the presenter classes 214, a set of presenter objects associated with the view 202 and the presenter system 200 are instantiated for the view—beginning with a root presenter object. It is noted that the constructor method call to the presentation engine object class to create the presentation engine 212 identifies the root graphical element for the view 202. After instantiation, the presentation engine 212 calls the graphical elements 206 to determine a presenter object type associated with the root graphical element for the view 202. After determining the graphical element's presenter type, the presentation engine 212 calls a method, on one of the presenter object classes 214 corresponding to the presenter object type identified by the graphical elements 206, to instantiate the root presenter object for the view 202.

As indicated by the path between the presenter classes 214 and the backing store, presenter objects, including the root presenter, access the graphical elements 206 of the backing store 208 to determine the properties of particular graphical elements. By way of example, a presenter object for a particular graphical element is able to identify any graphical element children of the particular graphical element and the presenter type for each child graphical element. Thereafter, the presenter object calls, for each identified child graphical element, a method on itself (e.g., GetChildProxyForElement 486) to instantiate a child proxy object from a child proxy class 222 of the presenter system 200. Child proxy objects are wrapper objects for presenter objects (instantiated from the presenter object classes 214) that are nested within the display space allocated to a parent presenter object. The child proxy class 222 meets encapsulation and security needs (e.g., a child presenter object limits access by a parent presenter object, or the application 204, to the contents of a presenter contained within the child presenter). Alternatively, the encapsulation layer provided by the child proxy objects is bypassed and the parent presenters directly access their child presenters.

The method on the presenter object for creating a child proxy object for an element, in an embodiment of the invention, calls a constructor method on the child proxy class 222 and passes the identity of the child graphical element to instantiate a new child proxy object and presenter object for the child graphical element. Once instantiated, the new child proxy object creates a presenter object for the child graphical element via a presenter constructor corresponding to the presenter type specified on the identified child graphical element. The child proxy object, in turn, returns its own reference to the parent presenter object. The parent presenter object maintains the returned child proxy object reference in an array of references to child proxy objects. As such the child proxy object array entries for a presenter object correspond to the graphical element children for a parent graphical element with which the parent presenter is associated.

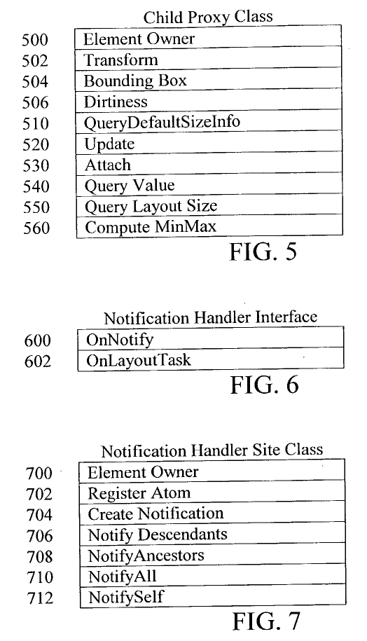

Another aspect of the graphical element arrangement/presentation architecture depicted in FIG. 2 is change notification. In an embodiment of the present invention, a set of notification handler classes 224 are provided for presenter objects instantiated from the presenter classes 214. The notification handler classes 224 are defined according to a notification handler base class 225. The notification handler base class 225 is an abstract class that defines an interface for the notification handler classes 224. The notification handler base class 225 provides the interface definition of two virtual methods (see FIG. 6), the implementation of which is provided in the notification handler classes 224 in accordance with their corresponding presenter classes 214. The notification handler classes 224 aid incremental layout updating—recalculating only the presenter objects effected by changes to a set of corresponding graphical elements. In an embodiment of the invention, a notification handler is specified for graphical element and view combinations. In cases where multiple presenters are created for a single graphical element/view combination, the single notification handler operates as the single source for tracking changes to the element for purposes of updating the multiple presenters for the element in a view. Each presenter type specifies a particular corresponding notification handler type. When a presenter object for an element is instantiated that requires a notification handler, the presenter system creates a corresponding notification handler of the specified type and links the notification handler to the presenter object.

Instances of the notification handler classes 224 determine which portions of the presenter objects are dirty and therefore require updating. Initially, a notification relationship is established between a graphical element and a notification handler created for a presenter in a view (e.g., view 202 for application 204). The notification handler receives change notifications associated with the graphical element in the backing store 208 through the presentation engine 212 of the presenter system 200. The notification handler determines a portion, if any, of the presenter that has been affected by the change to the element. The notification handler returns the affected portion information to the presenter system 200. The presenter is marked as “dirty” by the presentation engine 212. The presenter system 200 accumulates the “dirty” presenter information for all presenters in a data structure maintained for a view (e.g., view 202). At a later time, in response to a call to re-calculate the layout for a view, the presentation engine 212 of the presenter system 200 invokes an update method/operation only on the dirty presenters. Thus, the notification handler classes 224 enable limiting layout updates to the affected ones of the presenter objects created from the presenter classes 214.

The layout management system architecture embodying the present invention operates independently of any particular output hardware devices upon which the laid out elements are ultimately displayed according to their defined views. The layout/presentation management system architecture depicted in FIG. 2 performs a preprocessing step with regard to graphical display output. In an embodiment of the invention, the arranged output associated with the layout/presentation management system architecture is device independent. Thereafter, during a rendering stage the presenter objects render the re-calculated view to graphical output components of a computing system. However, in other embodiments of the invention, the output of the layout/presentation system is returned by either the presenter objects 214 or the presenter system 200 to the calling application 204, and the application 204 performs the rendering task. In an embodiment of the invention, the rendering commands, whether issued by the presenter objects derived from the presenter classes 214, the view 202, or the application 204, are passed to a graphics subsystem and graphics device drivers 234 on the user's computer. The graphics subsystem and graphics device drivers 234 transform the rendering instructions and data to a particular selected output device such as a monitor 236 or a printer 238.

In summary of the layout/presentation management system architecture described above, a presenter system 200 provides a device-independent layout processing platform for applications such as the application 204. Layout processing is performed by presenter objects instantiated from a set of presenter classes 214 hosted by the presenter system 200. The presenter system 200 is owned by the view 202. The presenter objects correspond to particular view states/renderings of the graphical elements 206. Separating view states (presenter objects) from element states (graphical elements 206) enables multiple view states/presenters to be independently designated for a single element state. The layout is separated into views, such as view 202, wherein each view corresponds to a display region such as a particular rectangle on an output screen allocated to the application 204 or a document page in graphical printer output. The separation of data and view states enables a single element to drive multiple views of that graphical element and thus enable a single graphical element to be displayed in a variety of views/ways.

Another aspect of the disclosed layout management system architecture is its high degree of extensibility. Extending the set of presenter classes 214 is facilitated by the presenter base class 216 provided by the presenter system 200 and the presenter host API of the presentation engine 212.

The above-described layout management system architecture supports a variety of advanced layout processing features for applications rendering graphical output to graphical user interfaces and printers. The ability to separate a single element (graphical element) into multiple view states (presenters) aids pagination and dividing elements into multiple columns (a form of pagination) in applications when rendering printer output or a printer output view of a document on a display screen. Such applications include web browsers and word processing programs.

Another benefit of the multiple presenters is the ability for applications to perform multiple attempts at fitting their content within a given display space. The applications can instantiate multiple tries on different presenter objects, for a single element, with different input parameters, and then allow a user to select a best one of the displayed views of the graphical element(s).

Yet another benefit arising from the above-described layout management architecture is the ability to perform incremental updates on a view comprising a set of presenters for a set of corresponding elements. Change is implemented on an element-by-element basis in the backing store (See, e.g., backing store 308 in FIG. 3). The notification handlers and the presenter system 200 provide an infrastructure for limiting update of a corresponding view to the presenters that have been affected by changes to corresponding elements in the backing store.

Still another benefit of the exemplary layout management architecture is the ability to adorn view states of elements embodied in previously created presenters. This is accomplished by chaining additional presenters onto a presenter of a type specified for a particular element type. Chaining enables developers to enhance user interfaces and document output by adding borders, backgrounds, etc. to a view state specified by a particular presenter type for an element.

Having described the general architecture of the layout management system embodying the present invention, attention is directed to FIG. 3 that depicts relationships between views, presentation engines, presenter objects within views, graphical elements, and notification handlers for a particular exemplary view.

Conceptually, a view defines a particular way for laying out a set of graphical elements represented in a backing store 208 according to specified presenters. In an embodiment of the invention, a view is defined by a rectangle in an output field (e.g., a display screen). In addition to a rectangle and its position, a view also specifies graphical elements and associated presenters contained in the view. Furthermore, it is noted that in an embodiment of the invention each view is associated with its own presenter system instance (e.g., presenter system 200a for view 202a and presenter system 200b for view 202b).

With continued reference to FIG. 3, the backing store 308 comprises an organized collection of graphical elements (Ex) associated with views 202a and 202b. The graphical elements (Ex) are entities of organized user content. Examples of elements include: a graphical user interface (GUI) button or text panel, a text editor window, a bitmap, etc. In an embodiment of the invention, the graphical elements (Ex) in the backing store 208 are arranged in the form of a tree. Each element (Ex) in the set of graphical elements 206 maintained within the backing store 208 is associated with a set of properties/placeholders (which can be either explicit or implied from other explicit properties/placeholders). One or more such properties/placeholders on the graphical elements specify a presenter type that is used to lay out and render the content of the graphical element in cooperation with other components of the computer system. In embodiments of the invention, the chained presenters are explicitly defined, or alternatively, are implied from other properties specified on an element (e.g., a “border” property of two pixels implies a border chained presenter). Property types specified for graphical elements depend upon the particular graphical element and include: color, font name, height, width, etc.

The backing store 208 is associated with potentially multiple views (e.g., views 202a and 202b). Each one of the potentially multiple views exclusively owns a set of presenter object instances corresponding to a set of graphical elements within the backing store 208. Thus, in the case of a graphical element being present in multiple views, a presenter object is created for the element within each view (e.g., presenter P2 and presenter P2′ for element E2). The graphical element with which the presenter is associated is specified in an element owner field and corresponds to the dashed lines from the presenters to their corresponding graphical elements. This is just one example of the presentation architecture represented in FIGS. 2 and 3 supporting multiple presenters operating upon information provided by a single graphical element.

As a consequence of a presentation architecture embodying the above-described ability to attach multiple views (and presenters) to a same collection of graphical elements in the backing store 208, a graphical user interface is capable of displaying multiple views of a same set of information provided by graphical elements. For example, in the an application such as MICROSOFT's POWERPOINT, two simultaneous views of a slide are supported, the main view and the preview (or thumbnail) view, for a same slide graphical element.

The ability to create multiple presenter object instances for a single graphical element also facilitates pagination of a single graphical element (e.g., document text) across multiple pages/columns (i.e., where one graphical element is split across two pages, two presenter objects are created for the element—one for each page). With reference to FIG. 3, a parent presenter object (e.g., P5) receives a passed property from a graphical element (e.g., E5) indicating that content within the element (e.g., text element E8) is presentable across two columns. Two child presenter objects P8a and P8b, corresponding to two separate and distinct column/page rectangles on the document, are instantiated under presenter P5 for displaying text provided by graphical element E8.

Yet another case of instantiating multiple presenters for a single graphical element arises in the case of adornments (e.g., borders, backgrounds, frames, etc.) assigned to a graphical element. An example of a chained presenter is provided by chained presenter Q4 for element E4 that provides a border around a rectangle defined by presenter P4 to hold the text supplied by a data field within element E4. Both presenter Q4 and presenter P4 are linked to/associated with a graphical element E4 by specifying the graphical element E4 in their element owner fields. In an embodiment of the invention, a parent presenter detects from an element corresponding to one of its children that a chained presenter is needed (e.g., a border of two pixels is specified on the element). In the case of the chained presenter Q4, when presenter P1 calls a method on itself to create a child (proxy) presenter for a child element E4, it recognizes from properties on E4 that a chained presenter (Q4) is needed. First the child proxy/presenter Q4 is created and is identified as a child presenter of presenter P1. Q4, in turn, creates the child proxy/presenter P4. P4 is thus a child presenter of presenter Q4. Information is stored within the child proxy for chained presenter Q4 identifying the next presenter (P4) in the chain.

Having described particular exemplary cases involving multiple presenters being linked to a same graphical element and creating multiple views (and presenter systems) for a set of graphical elements in a backing store 208, the relationships between the displayed entities in FIG. 3 are now described. As mentioned above, the views 202a and 202b own presenter systems 200a and 200b, respectively. The presenter system 200a created and supports a set of presenters 302 for the view 202a through code and a base class including an API to which the presenter classes are written. The presenter system 200b created and supports a set of presenters 303 for the view 202b.

As indicated by the lines between presenters (Px) and graphical elements (Ex) in the backing store 208, the presenters (Px) are associated with corresponding graphical elements (Ex). The presenters (Px) represent view states for corresponding graphical elements (Ex). The graphical elements (Ex) in the backing store 304 are maintained, by way of example, in a tree structure built by an application in one of many possible ways. Examples of such ways include running a text markup file through a parser, using code to instantiate the graphical elements, etc. The set of presenters 302 tree structure is built by the presenter system 200a in response to a call to a particular method on the interface (e.g., DoLayout) provided by its presentation engine. As explained previously herein above with reference to FIG. 2, the nodes of the presenter object tree are determined by the nodes of the graphical element tree associated with a particular view. The graphical elements within a view are determined by the root graphical element specified for the view, its children, grandchildren, etc.

The set of presenters 302 in view 1 are arranged hierarchically. A root presenter P1 has two children presenters P2 and P4 (Q4 is an adornment presenter on presenter P4). Presenter P2 has no children. Presenter P4 however has two children presenters P5 and P7. Presenter P5, in turn, has child presenters P8a and P8b that are associated with a single graphical element E8. Such sharing/dividing of a single graphical presenter between two presenter objects arises, by way of example, when a text graphical element E8 is divided between two columns of a parent text graphical element E5, which has a presenter (P5) of type TextPresenter. Presenter P5 initiates a column division process when the presenter P5 notes a property on E5 requesting E5's content (E8) to be divided across two columns. The presenters P8a and P8b correspond to the graphical existence of parts of graphical element E8 in the two columns.

It has been previously noted that a single graphical element can have multiple associated presenter objects. Three exemplary cases have been identified. In a first scenario, depicted by the multiple views 202a and 202b and corresponding presenter systems 200a and 200b in FIG. 3, a single graphical element (e.g., E2) has corresponding presenters P2 and P2′ associated with views 202a and 202b, respectively. Such views correspond, by way of example, to a thumbnail view and a full size view of a photograph image (E2) displayed at different regions of a user interface generated by a photographic image processing application. In this case, presenters P2 and P2′ are created for the element E2 in each view 202a and 202b containing the element. In a second scenario involving multiple presenters for a single element (e.g., text element E8), presenter elements P8a and P8b correspond to two columns within a rectangle defined by a single presenter element P5. Alternatively, such cases of multiple presenters in a view referencing a same graphical element arise, for example, when a parent performs multiple attempts at laying out a view and saves the tries. In a third scenario, a presenter (e.g., Q4) that is dependent upon another presenter (e.g., P4)—as opposed to the data state of a graphical element (e.g., E4)—is chained to the other presenter thereby enriching the display features provided by the original presenter. An example of presenter chaining is a border presenter providing a border adornment to a main presenter.

It has been previously noted above, with reference to FIG. 2, that child proxy objects instantiated from the child proxy class 222 are wrappers for each child presenter object of a parent presenter object. In the graphical depiction of the presenter tree structure for view 202a, the child proxy objects are represented by the arrowheads in the lines connecting a parent presenter to its child presenter objects. The child proxy objects limit access by a parent presenter object to its child presenter objects.

Notification handlers (Nx) are responsible for notifying corresponding presenters (Px) of data state changes to their graphical elements (Ex). Notification handlers Nx are not essential to the operation of the presentation/layout management system. Rather, they facilitate incremental updates to less than all the presenters when a change occurs in an element within a view.

With reference to FIGS. 4a and 4b, the presenter base class includes a set of methods, properties and fields. In an embodiment of the invention, the properties are accessed on a particular referenced presenter object by invoking get/set operations on the object. A background property 400 specifies a paint value for the presenter background. A background opacity property 402 stores a value specifying an opacity for the background. A border property 404 stores a value specifying the thickness of a border drawn around the edge of the presenter's layout space. The border property 404 stores, for example, four values indicating the border widths for the top, bottom, right and left sides of a rectangle assigned to a presenter. A border color property 406 specifies a value designating the color of the border around a presenter. A border style property 408 stores a value indicating one of a set of border display styles. Examples of border styles include: solid, groove, ridge, inset and outset.

A bounding box property 410 specifies the area (e.g., rectangle) in which the presenter graphics (or children) are drawn. The default size of the bounding box property 410 is the same as a size specified by a layout size field 460. However, the bounding box size can exceed the layout size thereby enabling the presenter to draw outside the layout size.

On the other hand, if a clip property 414 is set to true, then the presenter (and its children presenters) can not be drawn outside a rectangle specified by a layout size field 460. If the clip property 414 is set to true, then the bounding box property 410 is no larger than the layout size. This ensures that the drawn presenter does not render graphics outside its assigned layout space.

A children property 412 is an array, or alternatively any other suitable multi-element data structure, that stores references (e.g., handles, pointers, direct/indirect etc.) to child presenters nested within a parent presenter and their transformed locations within the parent presenter's layout space. The children property 412 is populated on first use in the context of an OnUpdate method call (discussed herein below) on the presenter. “On first use” refers to when a parent presenter sequentially requests the child collection and the children collection is populated with presenters corresponding to child graphical elements, of the graphical element corresponding to the parent presenter, from the tree of graphical elements in a backing store (e.g., backing store 208). The children property 412 facilitates establishing/maintaining a hierarchy reflecting nested relationships with regard to presenters in a view. In an embodiment of the invention, the array entries reference child proxy objects. The child proxy objects are wrapper objects for child presenter objects that are nested within the display space allocated to a parent presenter object. The child proxy object wrapper meets encapsulation and security needs (e.g., a child presenter limits access by a parent presenter to its contents).

The clip property 414, as explained above, controls whether the contents of a presenter will be confined, by clipping, to the layout size of a presenter as specified by the layout size field 460.

A set of properties designate the space allocated to content within the space of a presenter. In addition to the border property 404, a padding property 416 specifies an amount of space inside the border that is left unoccupied by content. A content height property 418 specifies a value indicating the height of content within a presenter—the height of the portion of the presenter that remains after accounting for the values specified in the border property 404 and the padding property 416. A content width property 420 specifies a value indicating the width allocated to content within a presenter after accounting for the border property 404 and padding property 416 dimensions. The content height property 418 and content width property 420, in combination, specify the area of a presenter that is potentially occupied in a presenter by content.

A height property 422 and a width property 424 specify the actual height and width of a presenter, and these two values include the content, padding and border dimensions. A default height property 422 and a default width property 424 specify default values assignable to the presenter when the height property 422 and width property 424 are not provided for a specific presenter object. A maximum width property 430 and minimum width property 432 specify bounds for the value assigned to the width property 424.

Yet another dimensional property for presenters is a margin property 434. The margin property 434 specifies a buffer space outside the presenter's border. The margin property 434 is specified by a child presenter and is accessed by its parent presenter when arranging a layout comprising a hierarchy of nested presenters.

A visibility property 436 specifies the visibility state of the presenter. The visibility property 436 is referenced to determine how (or whether) a graphical image corresponding to the presenter and its children is rendered. In an embodiment of the invention potential visibility states include: visible, collapsed, and hidden.

A number of presenter properties are utilized to link presenters to other entities in the layout/presentation management system. A presenter property 438 specifies the type of presenter that is used to layout and render the graphical element. The presenter type is initially set on a graphical element, and the presenter system 200 reads the presenter property 438 from the graphical element and instantiates a presenter object corresponding to the present type identified by the presenter property 438. The presenter property 438 is passed to an instantiator that, in turn, creates an instance of the identified presenter type. An IsMainPresenter property 440 specifies whether the presenter is the only presenter or the primary (e.g., last) presenter in a set of chained presenters associated with a graphical element object. Referring to FIG. 3, presenter P4 is the main presenter for the chain including B4 and P4. In an embodiment of the invention, the IsMainPresenter property 440 is a Boolean type property.

An element owner property 442 identifies the graphical element for which the presenter was instantiated. Referring again to FIG. 3, the ghost lines connecting the presenters (Px) to corresponding graphical elements (Ex) represent the associations designated by the content of the element owner property 442. A layout context property 444 specifies a global context that facilitates inter-presenter messaging during layout processing. The values stored in the layout context property 444 enable presenters to pass messages independently of the presenter system 200. A notification handler property 446 specifies a reference to a notification handler for the presenter. A notification handler type property 448 specifies a type of a notification handler referenced by the notification handler property 446.

A dirtiness property 450 specifies whether a particular presenter has been changed and therefore requires update processing. The presenter system 200 and associated components of the layout management architecture support incremental processing of a layout. The dirtiness property 450 maintained by each presenter indicates on a presenter-by-presenter basis whether a presenter needs to be updated.

With continued reference to FIG. 4a, an exemplary set of fields of the presenter base class are summarized. In an embodiment of the invention, the fields are Common Language Runtime (CLR) fields (similar to well known member variables in the C++ classes). In an embodiment of the invention, the properties described above are similar to fields. However, properties on the graphical elements (e.g., graphical elements 206) are owned and managed by the backing store (e.g., backing store 208). When a property changes, the backing store notifies the presentation engine of the change. The presentation engine (e.g., presentation engine 212 for presenter system 200) in turn notifies the appropriate notification handlers 224. Thus, in the case of a property, a change notification is received via one of the aforementioned notification handlers. Fields, on the other hand, are not managed by the backing store 208 (and are instead managed for example by the CLR). Hence, no change notifications are fired to the presentation engine when a field changes.

The layout size field 460 maintains dimensions of a presenter's allocated layout space. The layout size field 460 is utilized to arrange neighboring presenters in a page/user interface layout. An affects layout field 462 is a collection of properties (e.g., border, padding, etc.) of a presenter that, when changed, affect the layout of the presenter. An affects parent layout field 464 is a collection of properties (e.g., margin, visibility, etc.) of a presenter that, when changed for an element (e.g., Element A), dirties (i.e., potentially affects) the layout of a first parent of the element (Element A) having a specified presenter. An effects render field 466 is a notification mechanism that triggers invalidation and re-rendering of the presenter.

Referring now to the methods of the presenter base class 206 listed in FIG. 4b, an OnUpdate method 470 performs measuring and positioning tasks on a presenter for an element. Presenter authors overwrite a base class version of the OnUpdate method 470 to create/provide customized layout sizing/positioning behavior for an element's corresponding view.

A first default action of the OnUpdate method 470 is sizing the presenter. The OnUpdate method 470 receives presenter size dimensions in a passed BoxSizeInfo parameter. The OnUpdate method 470 sets the dimensions specified in the layout size field 460 according to the specified BoxSizeInfo and default width property 428 and default height property 426 values. Additional sources of sizing/positioning information for a presenter are incorporated into the disclosed presenter-based layout/presentation processing architecture, and such sources are utilized in alternative embodiments of the invention.

A second default task of the OnUpdate method 470 is positioning child presenters within the local dimension space of the presenter. The base class version of the OnUpdate method 470 iteratively calls the OnUpdate method 470 on children presenters identified in the children property 412 to discover their dimensions and children. Upon discovering and measuring the child presenters, the children are positioned within the parent presenter by invoking a transform method (discussed herein below) on the individual children. The iterative calls to the OnUpdate method 470 on children presenters end when no further children are specified on a presenter. In addition to registering its size in the layout size field 460 and iteratively calling/positioning children presenters, the OnUpdate method 470 returns a value to the caller indicating whether re-rendering is desired in view of the call to the OnUpdate method 470.

A register atom method 471 registers a string name for the presenter for the layout context 444 as well as any other appropriate lists of presenters including those maintained by extensions to the presenters. The register atom method 471 is called, for example, to communicate with another presenter object in a non-standard manner (e.g., a manner not currently supported by the presenter application program interface). Presenters register an atom and then set the object to whom they wish to communicate using the atom. For example, a child presenter wishes to communicate a text descent to a parent presenter. The child presenter registers an atom labeled/tagged “Descent” and receives an identification for the atom. The child computes the descent and sets the value in the atom using the identification. The parent presenter then uses the identification (that is also received by registering “Descent”) to retrieve the stored information.

An OnUpdateBoundingBox method 472 produces an updated bounding box property 410 for a presenter. The OnUpdateBoundingBox method 472 is called if the OnUpdate method 470 returns a value (e.g., “true”) indicating that re-rendering is required. The default implementation of the OnUpdateBoundingBox method 472, provided in the presenter base class, scans the children presenters identified in the children property 412 for the presenter and combines (i.e., performs a mathematical union of rectangles for) transformed children's Bounding Box properties with the dimensions of the presenter stored within the layout size field 460. The base class implementation of the OnUpdateBoundingBox method 472 also accesses the clip property 414, and if it is “true,” ignores children's bounding boxes. Instead the children presenters will be clipped to the layout size field 460 dimensions of their parent presenter. Presenters that draw outside of their layout size field 460 dimensions overwrite this method. Such customized presenter classes call the base presenter class and add additional “ink area” in their overwrite code. In an embodiment of the invention, presenters are allowed to estimate an “ink area” to be bigger than actually required. If the bounding box property 410 area is smaller than the area needed to draw the presenter, then the drawing is clipped based upon the bounding box property 410 dimensions specified for the presenter.

An OnRender method 474 is invoked upon presenters that request/require re-rendering. The OnRender method 474 is the primary call on a presenter to re-render the presenter and any of its children presenters. The OnRender method 474 is preferably invoked after the OnUpdate method 470 is invoked on all “dirty” presenters in a layout (e.g., a scene). In an embodiment of the invention, the OnRender method 474 is invoked on presenter objects based upon whether the OnUpdate method 470 call on a presenter object returned an indication that the presenter requests re-rendering. In an embodiment of the invention, the base class OnRender method 474 performs device-independent presentation/layout arrangement operations on a presenter. Other components, including the graphics subsystem and graphics device drivers 234, render the presenter's view in a device-specific format. The customized derivations of the OnRender method 474 include calls to graphics generation components of the computer system to render graphical document/user interface output.

In an embodiment of the invention, a base class version of the OnRender method 474 renders the contents of a presenter including any children in three layout processing stages. During an OnRenderBeforeChildren stage, the presenter object invokes operations designated for processing before processing any of its child presenters. In an embodiment of the invention, the base class implementation of the OnRender method 474 provides a hook for customization and does not specify any preprocessing operations during the OnRenderBeforeChildren stage. However, an exemplary customized replacement for this default behavior is establishing/drawing a custom background for the presenter's display area.

The base class version of the OnRender method 474, during a children rendering stage, accesses a presenter's children presenters identified in the children property 412. The OnRender method 474, is invoked in turn on each of the children presenters (to the extent requested by the children when the OnUpdate method 470 was performed). Thus, a top-level call to the OnRender method 474 cascades down to children presenters, and their children, until the bottom of a tree is reached (i.e., the presenter has no children). When the top-level call is complete, all the children presenters in a tree that requested re-rendering have been re-rendered.

During an OnRenderAfterChildren stage, the presenter object invokes operations that are to be executed after calling the OnRender method 474 on the children presenters identified in the children property 412. The base class version of the OnRender method 474 provides a hook for customization and does not specify any post-processing operations during the OnRenderAfterChildren stage. However, customization examples include annotations, adornments, etc.

If a presenter does not re-render anything other than its children, then there is no need to overwrite the base class version of the OnRender method 474. However, if anything is to be drawn by the presenter itself, then the base class for the OnRender method 474 is overwritten to render graphical data within the space assigned the presenter. The replacement code includes, by way of example, calls to the applications 230 and/or the graphics subsystem and graphics device drivers. A chained presenter is in the tree of presenters for a particular view. If the chained presenter requires re-rendering, then its OnRender method will be invoked by the presenter system in a manner similar to OnRender for a main presenter.

In the context of this application a “hit-test” refers to a process for identifying which presenter falls under a particular grid point of a graphical user interface grid space. For example, a hit-test is used to locate where a mouse pointer is located (e.g., over which presenter it sits) when a user selects one of the mouse buttons. An OnHitTestDetail method 476 returns data stored within a HitTestDetail structure for a presenter. A customized presenter class overwrites the base class implementation of the OnHitTestDetail method 476 to fill in the HitTestDetail structure to enable the presenter to return data other than the element and presenter that was hit, thereby providing, for example, more detailed information regarding the presenter such as a part of the presenter that was actually hit (e.g., a character position for text).

An OnCreateViewResult method 478 exposes parameters describing the calculated state of a presenter in a view result object. Users request the view result object for any element in the context of a designated view. The base class version of the OnCreateViewResult method 478 provides, through a view result object, the height, width, and top-left corner position of a presenter. If additional/alternative information regarding a presenter's state is desired, such as how many lines of text are contained in the presenter, then the base class version of the OnCreateViewResult method 478 is overridden to provide the desired information through the view result object.

A hit test method 480 initiates a hit test upon the sub-tree rooted at a specified presenter. Coordinates of a point (in the local coordinates of the presenter) are passed to the hit test method 480 upon which the hit test is to be performed. The hit test method 480 returns hit test data containing the results of the hit test for the designated point and presenter. The results contain all visuals hit by the point. A visual is a base object (e.g., a line) from which a presenter derives a display image. A visual is a graphics object having the capability to actually draw an image on the graphical display output. In a presenter's OnRender call, several calls are issued to a visual's API to render, for example, text, images, video, etc.

An OnGetBypassList method 482 provides a list of child presenters previously calculated for the identified presenter. The list of child presenters facilitates bypassing child presenters during layout calculation (e.g., comparing a new layout child with previously calculated layout children presenters and re-using a previously calculated one if there is a match to one in the list). If a presenter discovers its children by referencing the children property 412 collection, it does not have to override this method. However, if the presenter uses a GetChildProxyForElement method 486 (described below), the OnGetBypassList method 482 is generally overridden.

In an application of a layout system embodying the present invention, in the case where the GetChildProxyForElement method 486 is called, the OnGetBypassList method 482 is called before the OnUpdate method 470, and a presenter object creates and populates an array list with child proxy objects (described herein below with reference to FIG. 5) that it cached from a previous layout calculation. If a presenter object does not have a cache for storing the recalculated child proxy objects, all child presenters of the presenter object are recalculated on every call to the OnUpdate method 470 on the presenter.

A calculate bounds method 484 calculates and returns the bounds of a sub-graph rooted at an identified visual.

A child proxy object, as explained above, is a wrapper object that acts as an intermediary between a parent presenter and a child presenter for a particular graphical element. The child proxy objects for the child presenters of a particular presenter object are referenced as a collection within the children property 412 of the presenter object. The GetChildProxyForElement method 486 is a method on the parent presenter object that creates a child proxy object and presenter object for a specified element. The method, returns “null” if the specified element does not have a presenter.

An OnBeforeBypass method 488 is called when a presenter system 200 wants to “bypass” a particular presenter (i.e., to skip a call to the presenter's OnUpdate method 470). Such bypass occurs, for example, when the presenter is not dirty and the OnUpdate method 470 call input presenter dimension parameters (BoxSizeInfo) have not changed from the last OnUpdate method 470 call to the presenter. The OnBeforeBypass method 488 is a performance enhancing mechanism enabling presenters, that have their own custom collection of child proxy objects (that that use the GetChildProxyForElement method 486), to reuse the child proxy objects of their children when an update is performed on a layout (e.g., when only a small portion of a layout is affected by a change).

An OnDisconnectChildren method 490 removes all children presenter objects from a set of children presenters referenced in the children property 412 for a specified presenter. If the default children property 412 is overridden for a presenter class derived from the presenter base class 216, then the OnDisconnectChildren method 490 is also overridden to ensure proper disposal of children presenters.

A Min/Max pass is a special sizing pass used by partitioning presenters (e.g., DockPresenter) when sizing children to content. Knowing the minimum and maximum widths of children allow a parent to intelligently distribute space among multiple children sharing a particular width dimension. Without the min/max information provided by the MinMaxPass function, a partitioning presenter would require multiple passes to intelligently size to content. An OnMinWidth method 492 is called after a Min/Max pass. The OnMinWidth method 492 collects a MinWidth value that is a byproduct of a MaxWidth calculation. The base class version of the OnMinWidth method 492 issues an “I don't care” message which invokes a calculation pass with a ProposedSize=(0,infinity) and both directions “NotFixed.”

A presenter method 494 is a constructor method for a presenter instance. The presenter method 494 has no parameters. The presenter method 494 is invoked when the presenter is instantiated by the presenter system 200. The presenter method 494 sets the presenter instance up to enable invoking other methods (e.g., OnUpdate) on the presenter.

A QueueLayoutTask method 496 adds a specified layout task, to be performed with regard to the presenter object, to a queue of layout tasks to be executed by the presenter system 200. When the specified layout task reaches the front of the queue, the presenter system 200 calls an OnLayoutTask method 604 (described herein below) on the notification handler for the presenter.

An OnQueryValue method 498 returns a value corresponding to a specified calculated value for the presenter.

Having described the presenter base class 216, attention is directed to FIG. 5 that provides a summary of the properties and methods of an exemplary embodiment of the child proxy class 222. As previously explained, in an embodiment of the invention, the child proxy objects are wrappers for presenter objects that are children of a parent presenter object, and support limiting access by the parent to the resources of the child presenter objects. All communications (requests/responses) between a parent presenter object and a child presenter object are routed through the child proxy for the child presenter. The child proxy object holds a reference to the child presenter and routes calls/requests by the parent presenter to the child presenter.

In an embodiment of the presenter system 200, the child proxy class 222 includes an element owner property 500 that specifies the element in the graphical elements 206 with which the child proxy's referenced presenter is associated.

A transform property 502 positions the child presenter object (and its associated visuals) inside its parent presenter object. A transform is a standard graphics 3×3 transformation matrix on a visual object base class. When the transformation matrix is set up, a visual object, associated with the presenter's graphical element, places its child at an offset specified by the transformation matrix.

A bounding box property 504 specifies the rendering bounds of a child presenter. The rendering bounds of the child presenter can thus differ from the layout size of the child presenter.

A dirtiness property 506 specifies the dirtiness state of the child proxy's presenter. In an embodiment of the presenter system 200, the dirty state is either: clean, dirty bystander, or dirty. A clean state indicates that no changes have occurred to the child presenter since the last update of the view. A dirty state indicates that a change has occurred to the child presenter since the last update of the view. A dirty bystander state indicates that at least one of the child presenter's own children is dirty, but the child presenter itself is not dirty. Such states enable parent presenters to optimize update operations.

A QueryDefaultSizeInfo method 510 initializes the dimensions of a child presenter from default values supplied by the child presenter's parent presenter.

An Update method 520 requests a child proxy to invoke the OnUpdate method 470 on the child presenter object. The parent presenter calls the Update method 520 on the child proxy when the parent presenter seeks calculation of the child presenter's layout. The Update method 520 call includes two passed parameters. Box size information specifies the dimensions of the box within which the child is to calculate a layout, and, if pagination is activated, the parent presenter passes page information in a page descriptor parameter (See FIG. 10 described herein below). The Update method 520 thus provides a layer between a caller and a child presenter object that enables screening/filtering of such requests to a child presenter object. The Update method 520 provides a way to bypass calls normally routed to the OnUpdate method on the child presenter. For example, the Update method 520 call is invoked in cases where a child presenter has not changed and the input parameters (box size information and page description) are unchanged.

An attach method 530, issued by a parent presenter to a child proxy, invokes an OnRender command on a child presenter associated with the child proxy.

A query value method 540 provides a presenter value corresponding to a calculated value type (property) identified in the method call. The query value method 540 call is delegated to the corresponding OnQueryValue method 498 on the child presenter object.

A query layout size method 550 provides calculated layout size parameters. The query layout size method 550 call is delegated to the corresponding OnQueryValue method 496 on the child presenter object. A compute MinMax method 560 provides a minimum and maximum width of a child presenter.

Referring to FIG. 6, the set of base classes associated with the presenter system 200 include a notification handler base class. As explained previously herein above, the notification handler objects receive all notifications regarding changes potentially effecting a presenter associated with a particular view, accumulate dirtiness information, and facilitate determining whether an associated presenter object requires updating. Both methods on the notification handler base class receive, as a parameter, an object including a method that provides relevant information from the element in the graphical elements (e.g., graphical elements 206) with which the notification handler is associated.

The notification handler base class includes an OnNotify method 600 that provides notification of dirtiness of a particular associated presenter object. The OnNotify method 600 potentially includes additional, customized derivative notification tasks (by overriding the default action of providing a dirtiness property value) that are executed in response to receiving a notification. The OnNotify method 600 receives as an input parameter information about a change that resulted in a notification. The OnNotify method returns a Boolean value indicating whether or not the notification handler can process the change by itself (or whether it is necessary to notify the notification handler for an ancestor presenter in the presenter tree for a view). The method also returns a dirtiness value indicating whether the presenter is “clean”, “dirty”, or a “dirty bystander”.

An OnLayOutTask method 602 executes any tasks previously queued by an associated presenter through the QueueLayoutTask 496.

Referring to FIG. 7, the set of base classes associated with the presenter system 200 further includes a notification handler site class. The notification handler site class is a site object passed to a notification handler object that enables the notification handler to invoke notification services supported by the presenter system 200.

The notification handler site class includes an element owner property 700 specifying the graphical element object with which the notification handler site object is associated.

A register atom method 702 registers a provided string name within the layout context 444 for a notification handler. The functionality of the register atom method 702 is similar to register atom method 471 described herein above with reference to the presenter base class. The register atom method 702 is thus a means for communicating requests by a notification handler to other objects (e.g., presenter objects).

A create notification method 704 creates a new presenter notification object and initializes its fields based upon passed parameters. The passed parameters include an identification of an atom type (indicating the presenter notification object type) and notification data.

A notify descendents method 706 invokes the OnNotify method 600 on the notification handlers associated with the descendants of a presenter, with which the notification handler site is associated, to pass a specified presenter notification. The notify descendants method 706 performs the function of notifying descendant presenters of any changes to a parent presenter (e.g., re-sizing). Similarly, a notify ancestors method 708 invokes the OnNotify method 600 on the notification handlers associated with the ancestors of a presenter, with which the notification handler site is associated, to pass a specified presenter notification. Ancestors are determined by traversing the graphical element tree (see, FIG. 3) in the backing store 208. The graphical elements represented in the backing store include a property that specifies the parent (immediate ancestor) of the graphical element. A notify all method 710 invokes the OnNotify method 600 on the notification handler objects for all presenters in a presenter tree owned by a view to pass a specified notification. Finally, a notify self method 712 provides a means for a presenter to invoke the OnNotify method 600 to mark itself dirty.

Turning to FIG. 8, an exemplary view object class is depicted from which the view 202 is instantiated. View objects possess an instance of the presenter system (e.g., presenter system 200) and are the visual root of all visuals created within the created presenter system instance. The view object initiates all calculations on the presenters within the view. A view method 800 is a constructor method that is used to create a new view object. The view receives as a passed parameter a reference to an element that is the root graphical element of the view. A RootElement property 802 returns a reference to a root graphical element for the view (that was established through the above-described view method 800).

A DoLayout method 804 creates a new presenter tree for the view and returns a reference to the new tree. The DoLayout method 804 receives as input parameters: a proposed height and width for the view rectangle as well as two Boolean values (fixedwidth and fixedheight) that establish whether the proposed dimensions can be altered during the DoLayout method 804 execution.

A ViewSize property 806 sets the dimensions of the view. The ViewSize property 806, a write-only property, is utilized when the view object is hosted within a window, and the ViewSize property 806 represents an initial size from which a layout operation is performed.

A GetViewResult method 808 receives a graphical element reference as an input, and the GetViewResult method 808 returns the resulting view for the graphical element. A value of null is returned in the event that the graphical element is not located within the set of graphical elements for the view.

A HitTest method 810 performs a hit test at a passed point within a coordinate system of the view. The HitTest method 810 returns a first non-transparent hit test target. If no graphical element is hit, then the method returns “false.”

A CreatePage method 812 receives as input parameters BoxSizeInfo (see, FIG. 9 described herein below) and PageDescriptor (see, FIG. 10 described herein below). The CreatePage method 812 creates a new page, based upon the input parameters, and returns the child proxy object corresponding to the root graphical element for the page.

Turning to FIG. 9, an exemplary BoxSizeInfo structure is depicted. The BoxSizeInfo structure specifies a set of dimensions for presenters and their child presenters within a view, and how those dimensions should be treated by the recipient. A proposed size property 900 sets forth the proposed size for a child presenter within the view. Initially, the value of the proposed size property 900 comes from properties for a child graphical element in a backing store. It can be modified by a parent presenter before passing to a child. A parent size property 902 is a proposed size for a parent presenter. The parent size property 902 is used, by way of example, to calculate dimensions, from percent values of the parent, for child presenters. The BoxSizeInfo structure also includes two Boolean value properties, FixedWidth 904 and FixedHeight 906 that instructs the recipient presenter whether the supplied dimension as an imposed (fixed) value, or whether the dimension value is merely a suggested height or width.

Turning to FIG. 10, parts of an exemplary page descriptor structure are depicted. A page descriptor includes a PageSize property 1000. The PageSize property 1000 is a read only property specifying the size of a page. It is initialized when the page descriptor structure is created. A break record property 1002 is a structure including: a character position start that identifies the first character of the current presenter that is on a next page (with respect to the graphical element that is the root of a view that is being paginated), a number of characters (counting back from the character position start) that can invalidate a previous page; and an IsDirty Boolean value that indicates whether a break record (covering a particular character range within a paginated graphical element) is invalidated by a change to the backing store.

The page descriptor structure also includes an AvailableSize property 1004. The complete page may not be available to a presenter upon commencing an OnUpdate method on the presenter. The AvailableSize property 1004 indicates the space remaining on the page for a presenter. The AvailableSize property 1004 is initialized to a value for a page size.

Turning to FIG. 11, a set of methods are identified that are carried out by the presentation engine 212 of the presenter system 200 created by the view 202 (see, FIG. 2). A constructor method 1100 on the presentation engine 212 accesses the view 202 that contains a reference to the root graphical element for the view (provided by the graphical elements 206 tree. A DoLayout method 1102 receives a width and height as passed parameters representing the dimensions of the view 202 and, in response, commences executing a layout process with regard to the contents of the graphical elements 206. An UpdateLayout method 1104, executed after executing the DoLayout at least once, commences applying incremental changes to a previously calculated layout for the view 202. A CreatePage method 1106 receives, as an input parameter, box size information (BoxSizeInfo) that contains the dimensions of a page to be laid out, and a page descriptor containing information regarding how to start the particular page. Rather than lay out all content under a root of the graphical elements 206 for the view 202, the CreatePage method 1106 lays out only a single page of interest.

An exemplary layout processing architecture has been described with reference to FIGS. 1-11. The exemplary architecture includes separate view states (presenter objects) linked to element data states (graphical element objects). The exemplary architecture includes a presenter system 200 that facilitates extending the view layout/presentation capabilities through a presenter base class 216 from which new presenter object classes, embodying new layout/presentation functionality, are derived. The system and architecture disclosed herein also include a notification mechanism linking elements to their corresponding presenter objects to selectively invoke recalculating portions of a view in response to changes. The illustrative object base classes are illustrative of many potential alternative ways of carrying out the extensible architecture embodying the present invention and should not be viewed as limiting the scope of the invention.

Having described a set of components making up an exemplary presentation/layout processing architecture embodying the present invention, attention is directed FIG. 12 that depicts the general progression of processing changes to a graphically displayed element. Initially, at 1200 the backing store 208 changes. For example, the application 204 executes an operation that results in a status and/or content change to one or more of the displayed components of a graphical user interface for the application. In response, at step 1202 a change notification, arising from a change to a graphical element in the backing store, is received by the presentation engine 212 of the presenter system 200.

By way of background, with regard to step 1204, the presenter system 200 maintains associations between elements and presenters in element-to-presenter information (EPI). Whenever a presenter is created for a graphical element, a reference to that presenter is created on the element and is stored in EPI maintained by the presenter system. If a graphical element has more than one presenter, then there will be multiple references (one per presenter) in the graphical element's EPI. When a property changes on a graphical element, the following steps occur:

(a) The backing store 208 notices the change on the graphical element,

(b) The backing store 208 notifies the presentation engine 212 of the change, with reference to the graphical element that has experienced a change to one of its properties,

(c) The presentation engine 212 walks the EPI of the graphical element that changed and determines the presenters that have been created for the graphical element, and

(d) Once the presenter is determined, the presentation engine 212 obtains a reference to the presenter's corresponding notification handler (through the notification handler property 446 on the presenter).

Thus, in view of the above, at step 1204, the presentation engine 212 of the presenter system 200 determines the identity of a presenter to which the change notification applies. As explained above, the presenter system maintains a list of presenters that were instantiated for the element in its EPI. After determining a presenter to which the change notification applies (assuming for this example that only a single presenter exists for the element), the presentation engine 212 of the presenter system obtains a reference to a notification handler for the presenter through the notification handler property 446 on the identified presenter.

Thereafter, during step 1206 the presentation engine 212 of the presenter system 200 forwards the change notification to the notification handler using the reference obtained during step 1204. In an embodiment of the invention, step 1206 is carried out by invoking the OnNotify method 602 on a particular notification handler object.

After receiving the change notification from the presenter system, during step 1208 (e.g., during execution of the OnNotify method 602) the notification handler determines the actions, if any, required by the presenter in response to the changes, during step 1200, to the graphical element in the backing store 208. In an embodiment of the invention, the notification handler determines what portion, if any, of a corresponding presenter requires updating in view of the received change notification. Such portions include, by way of example, the children of the presenter and the presenter itself.

Thereafter, during step 1210 the notification handler (e.g., OnNotify method 602) returns a result that enables the corresponding presenter to determine and execute actions in view of the change notification received by the presenter system 200 during step 1202. In an embodiment of the invention, the form of the returned result is notification handler/presenter-specific. In some cases, the returned result simply labels the presenter as “dirty”—thereby invoking a complete re-calculation of the corresponding presenter. In other cases, information is provided to selectively invoke only portions of the presenter's view re-calculation capabilities.

In an embodiment of the invention, the presentation engine 212 of the presenter system 200 receives the returned result from the notification handler for a presenter during step 1210. Thereafter, at step 1212 if the changes to the backing store did not raise a need to recalculate the presenter, then control passes to decision block 1216. However, if at step 1212 the returned result indicates that the presenter needs to be re-calculated, then control passes to step 1214 wherein the presenter system 200 adds the presenter to the set of “dirty” presenters that require re-calculation. In an exemplary embodiment of the invention, the presenter system sets the dirtiness property 450 on the corresponding presenter (indicating a need to re-calculate the presenter) and adds the presenter to a set of presenters that need to be re-calculated. The presenters also specify information describing the extent of changes that led to the setting of the dirtiness property 450. Control then passes to step 1216.

At step 1216, if a parent presenter does not exist for the presenter associated with the notification handler of present interest, then control passes to the End 1218. If a parent presenter does indeed exist, then control passes from step 1216 to step 1220 wherein a notification is created for (passed to) the parent presenter's notification handler (resulting in the notification handler for the parent processing the notification) as indicated by the dotted return line to step 1208.

Thus, the set of steps depicted in FIG. 12 enables the presenter system 200 to accumulate a list of the presenters that have been “dirtied” as a result of changes to the backing store 220 since last calculating a layout for a document/user interface.

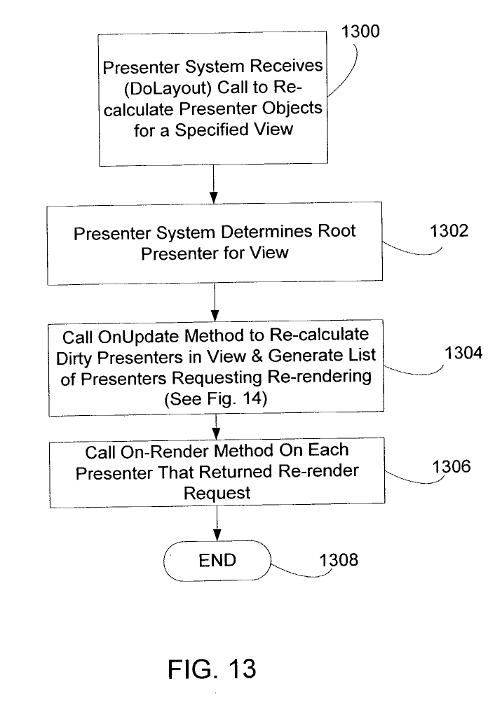

Turning now to FIG. 13, a flowchart describes an exemplary process for re-calculating/re-rendering a document/user interface according to changes to presenters in a particular view (see, FIG. 12 described herein above). In an embodiment of the invention, the application 204 controls updates to its view 202 and invokes view update procedures, such as the one summarized in FIG. 13, in response to events such as: a period expiring, a document print request, or a change in status of a graphical user interface.

Initially, during step 1300 the presenter system 200, and particular the presentation engine 212 receives a call to the DoLayout method 1102 (described herein above with reference to the presentation engine 212 API description). In response to receiving the DoLayout method 1102 call by the application 204 the presenter system 200 re-calculates presenter objects contained within the view 204 to accommodate changes to elements in the backing store 208 since a last DoLayout method 1102 call.

In an embodiment of the present invention wherein the presenters for a view are hierarchically arranged (see, FIG. 3), the presenter system 200 initially determines the root presenter for the view in step 1302. In an embodiment of the invention, the root presenter is identified by the presenter property on the root element that is submitted to the view (e.g., view 204a) and hence the presenter system (e.g., presenter system 200a). After determining the root presenter, control passes to step 1304 wherein the presenter system 200 commences traversing the tree of presenters for the view and re-calculating each dirty presenter.

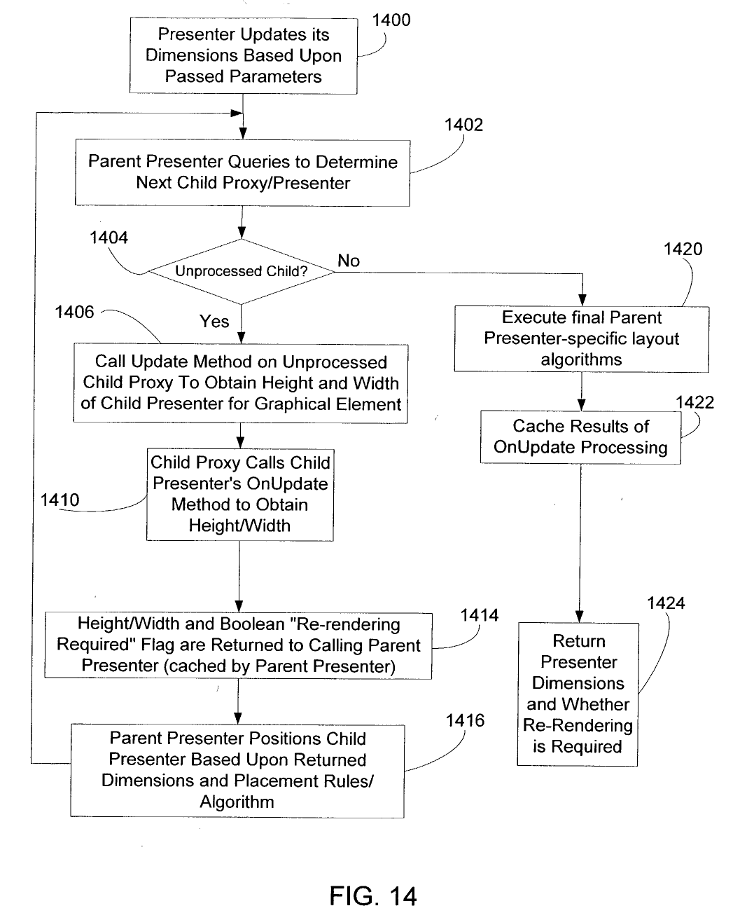

During step 1304 the presenter system 200 invokes the OnUpdate method 470 on each dirty presenter in the view. The called OnUpdate method 470 is passed a height and width of a rectangle within which the presenter is to re-calculate its layout. After re-calculating its layout, the presenter caches its result. Thus, upon completion of step 1304 the previously dirty presenters have been re-calculated and their results cached for easy access during subsequent re-rendering. The dirty bit is cleared on each of the called presenters. A set of steps performed during an exemplary OnUpdate method 470 call are described herein below in greater detail with reference to FIG. 14.

There are a number of ways in which to clean dirty presenters during step 1304. However, in an embodiment of the invention, the presenter system 200, and in particular the presentation engine 212 UpdateLayout method 1104, leverages the hierarchical relationships between presenters in a view to simplify its role in completing step 1304. In particular, during execution of the OnUpdate method 470 each called presenter iteratively calls (or alternatively requests the presenter system 200 to call) the OnUpdate method 470 on all children of the called presenter. Thus, the presenter system 200 starts the traversal of the presenter tree at the root presenter's OnUpdate method 470 (e.g., presenter P1 of FIG. 3) and supports subsequent calls to child presenters as the OnUpdate method 470 call traverses the branches of the hierarchical presenter tree to re-calculate dirty presenters. The iterative calls to the OnUpdate method 470 on the children presenters ensures that all presenters in the view are traversed, and if the presenters are dirty they are re-calculated.

Upon completion, each OnUpdate method 470 called during step 1304 resets its dirtiness property 450 indicating that it has been re-calculated or “cleaned.” Each OnUpdate method 470 also returns a value to the caller indicating whether the presenter requires re-rendering (i.e., re-drawing). In an embodiment of the invention the returned value is a Boolean value. If “true”, then re-rendering is required. If “false” is returned then re-rendering is not necessary. After processing each of the dirty presenters for a view during step 1304, control passes to a rendering step 1306 wherein presenters identified in the list of presenters requiring re-rendering are processed.

During step 1306 the presenter system 200 invokes the OnRender method 474 on each presenter identified in the list of presenters requesting re-rendering. The operation of an exemplary embodiment of the OnRender method 474 is described with reference to FIG. 14. In the base class implementation of the OnRender method 474, the presenter does not draw anything, and instead iteratively calls the OnRender method 474 on its children and/or chained presenters to fill its allocated space (e.g., rectangle). Customized versions of the OnRender method 474 render bitmaps through calls to the application 204 and/or the APIs of the graphics subsystem and graphics device drivers 234. After processing all the presenters requesting re-rendering during step 1306, control passes to the End 1308, and control returns to the caller of the DoLayout method call 1102 on the presentation engine for the particular view.

Turning to FIG. 14, a flowchart summarizes the steps of the OnUpdate method 470 performed to re-calculate a presenter of a view. The OnUpdate method 470 calculates a new layout for a presenter, including any children presenters, and caches the results for access during a re-rendering stage. In the example provided herein below, the OnUpdate method 470 call to each presenter passes a set of dimensions specifying the limits to the view space (e.g., rectangle) that can be occupied by the layout of the presenter. The set of dimensions specifies, for example, the height and width and whether those values can be modified during execution of the OnUpdate method 470 call. However, the invention contemplates re-calculating presenters based upon any one or more of a variety of passed parameters, including view space dimensions, that affect a layout.

During step 1400, the presenter performs any needed sizing operations, arising from the passed parameters, before calling any child presenters (via child proxy objects) to perform their updates. The content of such work is dependent upon the design of a particular presenter type. Thereafter, the presenter calls upon the presenter system 200 to locate and update any children presenters of the current presenter. During the pre-processing stage, the presenter potentially detects the need to create a new page/column and creates a new child proxy/presenter to handle the new page/column for the view.

Next, during step 1402, the OnUpdate method 470 on the current parent presenter determines a next child presenter to call to update its layout. It is noted that this step, at least in a first instance requires the parent presenter to determine the existence of a child element and create a corresponding child proxy/presenter. In later iterations, the parent presenter can use the cached child proxies identified in its children field 412 to identify a next remaining (unprocessed) child proxy/presenter-i.e., a child presenter that has not yet been called during the current iteration of the OnUpdate method on the current parent presenter.

The parent presenter receives a response from the backing store or determines on its own from its children property 412 whether a child presenter remains to be processed, and at step 1404, if no unprocessed child remains to be updated, then control passes to step 1420 (described herein below). Otherwise, if the presenter does have an unprocessed child presenter, within its children property 412, that has not yet been updated, then control passes to step 1406.

At step 1406, the presenter calls the Update method 520 on the returned child proxy, that is interposed between the parent presenter and a current child presenter of interest, to obtain a height and width of a child presenter with which the child proxy is associated. The child presenter is associated with a particular graphical element (specified in its element owner field 442).

At step 1410 the child proxy calls the OnUpdate method 470 on the child presenter with which the child proxy is associated. The OnUpdate method 470 calculates an updated height and width of the child presenter (and whether re-rendering is required). It is noted that during step 1410 the OnUpdate method 470 is recursively invoked by child presenters until a called child presenter determines, at step 1402 that it has no children and returns to its calling parent presenter (through its child proxy). After invoking the OnUpdate method 470 on the child presenter, control passes to step 1414.

Thus, at step 1414 the calling presenter parent (from step 1406) receives a response to the Update method call 520 to the identified child proxy. The response includes the height and width of the child presenter as returned parameters. The response also indicates whether the called child presenter requires re-rendering. Next, at step 1416 the parent presenter positions the called child presenter within the parent presenter's allocated layout space based upon a placement algorithm/policy. In an embodiment of the invention, during step 1416 the parent presenter places the child presenter within its layout based upon the height and width parameters of the child presenter received by the presenter during step 1414.

Control then returns to step 1402 where the OnUpdate method 470 of the parent presenter continues to update any remaining child presenters (through their child proxy wrapper objects).

If at step 1404, no child (element or proxy/presenters) remain to be processed/updated, then control passes to step 1420. At step 1420 the OnUpdate method 470 of the called presenter performs customized layout functions including potentially further calls to the OnUpdate method 470 on the children presenters to tune the layout for the presenter.

At step 1422, or potentially any point where new information is derived by the OnUpdate method 470, the results of the layout processing are cached for later use during a re-rendering stage of the graphical view processing.

After update processing is complete for the presenter, including all children of the called presenter, at step 1424 the presenter returns its dimensions to the caller (presenter system 200) as well as a value indicating whether the presenter needs to be re-rendered.

It will be appreciated by those skilled in the art that a new exemplary platform and exemplary methods have been described for managing layout/presentation processing of graphical document/user interface output within a computing environment including graphical output devices such as a graphical user interface display or a printer. In view of the many possible environments to which the principles of this invention may be applied and the flexibility of designing and carrying out software utilities and tools, it should be recognized that the embodiments described herein are meant to be illustrative and should not be taken as limiting the scope of invention. Those skilled in the art to which the present invention applies will appreciate that the illustrated embodiments can be modified in arrangement and detail without departing from the spirit of the invention. Therefore, the invention as described herein contemplates all such embodiments as may come within the scope of the following claims and equivalents thereof.

What is claimed is:

1. A graphical output layout management system for arranging and maintaining graphically displayed output of programs executing on a computing system, the graphical output layout management system comprising:
graphical elements containing data representing displayable content of a program;
presenters defining display states for the graphical elements, wherein a presenter of a particular type maintains a layout description for a corresponding graphical element; and
a presenter system, including a presenter host interface comprising a method for preparing a layout for a view, according to a set of presenters associated with graphical elements contained within the view.

2. The graphical output layout management system of claim 1 wherein the presenter system further comprises a presenter base class, and wherein the set of presenters are instantiated from presenter classes derived from the presenter base class.

3. The graphical output layout management system of claim 2 wherein the presenters include an update method for calculating layout properties for the presenter.

4. The graphical output layout management system of claim 3 wherein the presenters include a render method for generating instructions issued to a graphics output subsystem of the computer system.

5. The graphical output layout management system of claim 2 wherein the presenter classes include predefined presenter classes and external presenter classes.

6. The graphical output layout management system of claim 1 wherein each of the presenters calculates a layout state for a corresponding graphical element based upon layout parameter values specified on the presenter.

7. The graphical output layout management system of claim 1 further comprising a set of notification handlers, each notification handler being associated with a particular one of the set of presenters in the view, and wherein a notification handler processes a change to a graphical element to determine whether to update a corresponding presenter.

8. The graphical output layout management system of claim 7 wherein each presenter specifies a type of notification handler that provides change notifications to the particular presenter regarding an associated graphical element.

9. The graphical output layout management system of claim 8 wherein a notification handler determines a part of a corresponding presenter that requires updating in view of changes to an associated graphical element.

10. The graphical output layout management system of claim 7 wherein the presenter system registers, through the notification handlers, presenters that require updating based upon changes to corresponding graphical elements.

11. The graphical output layout management system of claim 1 wherein a graphical element instance of the graphical elements is associated with multiple presenters.

12. The graphical output layout management system of claim 11 wherein the multiple presenters with which the graphical element instance is associated are of a same type.

13. The graphical output layout management system of claim 12 wherein the multiple presenters correspond to distinct columns within a same view.

14. The graphical output layout management system of claim 12 wherein the multiple presenters correspond to distinct pages in a document view of a single graphical element.

15. The graphical output layout management system of claim 111 wherein a first presenter and a second presenter, of the multiple presenters associated with the graphical element instance, are associated with respective first and second distinct views.

16. The graphical output layout management system of claim 15 wherein the first and second distinct views are hosted by respective first and second presenter systems.

17. The graphical output layout management system of claim 1 wherein the view corresponds to a rectangular region within a graphical display space.

18. The graphical output layout management system of claim 11 wherein the multiple presenters associated with the graphical element instance are of different types.

19. The graphical output layout management system of claim 18 wherein one of the multiple presenters comprises an adornment presenter to a main presenter.

20. The graphical output layout management system of claim 1 wherein presenters within a view are hierarchically arranged such that child presenters are contained within a region specified by a corresponding parent presenter.

21. A presenter system for incorporation within a graphical output layout management system for processing a layout, on behalf of a program providing graphical elements containing data representing displayable content of the program, through presenters defining display states for the graphical elements, and wherein a presenter maintains a layout description for a corresponding graphical element, and wherein the presenter system hosts and arranges the presenters associated with graphical elements within a view, the presenter system comprising:
a presenter base class from which presenter classes are derived, and wherein the presenters are instantiated from the presenter classes; and
a presenter host interface comprising a set of methods including at least a method for preparing a layout embodied in the set of presenters associated with graphical elements within the view.

22. The presenter system of claim 21 wherein the presenter base class specifies a customizable update method, overridden by derived presenter classes, for calculating layout properties for a presenter.

23. The presenter system of claim 22 wherein the presenter base class specifies a customizable render method, overridden by derived presenter classes, for generating instructions issued to a graphics output subsystem of the computer system.

24. The presenter system of claim 21 wherein the presenter system supports a set of presenter classes that includes predefined presenter classes and external presenter classes.

25. The presenter system of claim 21 wherein the presenter base class specifies a method for calculating a layout state for a graphical element based upon layout parameter values specified on an associated presenter.

26. The presenter system of claim 21 further comprising a notification handler base class from which notification handler classes are derived, and wherein each notification handler instantiated from a notification handler class is associated with a particular presenter in a view, and wherein a notification handler processes a change to a graphical element to determine whether to update a corresponding presenter.

27. The presenter system of claim 26 wherein the base presenter class includes a placeholder for a presenter to specify a type of notification handler that provides change notifications to the particular presenter regarding an associated graphical element.

28. The presenter system of claim 26 wherein the presenter system registers, through notification handlers, presenters that require updating based upon changes to corresponding graphical elements.

29. The presenter system of claim 21 wherein the presenter system is associated with a view characterized by a root graphical element and an assigned area within which to display the root graphical element and its child graphical elements.

30. The presenter system of claim 29 wherein the view corresponds to a rectangular region within a graphical display space.

31. The presenter system of claim 21 wherein the presenter host interface includes a constructor for instantiating the presenter system for laying out a display for a view comprising a set of graphical elements.

32. The presenter system of claim 31 wherein the view is specified at least in part by a root graphical element passed to the constructor.

33. The presenter system of claim 21 wherein the presenter system supports chaining multiple presenters such that a first presenter provides and adornment for a second presenter associated with a graphical element.

34. The presenter system of claim 21 wherein the presenter base class includes a placeholder for specifying child presenters, thereby supporting creation of a hierarchical tree structure of presenters within a view such that child presenters are contained within a region specified by a corresponding parent presenter.

35. A method for processing a layout, on behalf of a program providing graphical elements containing data representing displayable content of the program, through presenters defining display states for the graphical elements, and wherein a presenter maintains a layout description for a corresponding graphical element, and wherein the presenter system hosts and arranges the presenters associated with graphical elements within a view, the method comprising:
providing a presenter system comprising a presenter base class and a presenter host interface comprising a method for creating a layout embodied in a set of presenters associated with graphical elements within a view;
receiving a request, by the presenter host interface, to generate a layout for a set of graphical elements within a view; and
instantiating, for the set of graphical elements, corresponding presenters from a set of presenter classes derived from the presenter base class and invoking a method on each instantiated presenter to calculate a layout state for a graphical element corresponding to the presenter.

36. The method of claim 35 further comprising the step of:
providing a notification handler base class specifying an interface for a set of notification handlers that facilitate incremental update to a layout based upon changes to corresponding graphical elements.

37. The method of claim 35 further comprising organizing the presenters for the view in the form of a hierarchical tree.

38. The method of claim 35 wherein an instance of the presenter system is created in response to a call to create a layout for a view, thereby creating a distinct presenter system, and corresponding presenters, for each view.

39. The method of claim 35 wherein the presenter base class specifies an update method for calculating layout properties for a presenter instance associated with a particular graphical element.

40. The method of claim 35 wherein the presenter base class specifies a render method for generating instructions issued to a graphics output subsystem.

41. The method of claim 35 wherein the presenter system supports derivation of predefined presenter classes and external presenter classes.

42. The method of claim 35 wherein the presenter classes correspond to differing types of presenters that layout different types of graphical element content.

43. The method of claim 35 wherein presenters within a view are hierarchically arranged such that child presenters are contained within a region specified by a corresponding parent presenter.

44. A computer-readable medium including computer-executable instructions for facilitating processing a layout, on behalf of a program providing graphical elements containing data representing displayable content of the program, through presenters defining display states for the graphical elements, and wherein a presenter maintains a layout description for a corresponding graphical element, and wherein the presenter system hosts and arranges the presenters associated with graphical elements within a view, the computer-executable instructions facilitating performing a method comprising:
providing a presenter system comprising a presenter base class and a presenter host interface comprising a method for creating a layout embodied in a set of presenters associated with graphical elements within a view;
receiving a request, by the presenter host interface, to generate a layout for a set of graphical elements within a view; and
instantiating, for the set of graphical elements, corresponding presenters from a set of presenter classes derived from the presenter base class and invoking a method on each instantiated presenter to calculate a layout state for a graphical element corresponding to the presenter.

45. The computer-readable medium of claim 44 further comprising computer-executable instructions for:
organizing the presenters for the view in the form of a hierarchical tree.

46. The computer-readable medium of claim 44 wherein computer-executable instructions facilitate creating an instance of the presenter system in response to a call to create a layout for a view, thereby creating a distinct presenter system, and corresponding presenters, for each view.

47. The computer-readable medium of claim 44 wherein the presenter base class specifies an update method for calculating layout properties for a presenter instance associated with a particular graphical element.

48. The computer-readable medium of claim 44 wherein the presenter base class specifies a render method for generating instructions issued to a graphics output subsystem.

49. The computer-readable medium of claim 44 wherein the presenter system supports derivation of predefined presenter classes and external presenter classes.

50. The computer-readable medium of claim 44 wherein the presenter classes correspond to differing types of presenters that layout different types of graphical element content.

51. The computer-readable medium of claim 44 wherein the presenter base class specifies a placeholder for child presenters, thereby facilitating hierarchically laying out presenters within a view such that child presenters are contained within a region specified by a corresponding parent presenter.
